(19) United States
(12) Patent Application Publication
(10) Pub. No.: US 2023/0271896 A1
(43) Pub. Date: Aug. 31, 2023

(54) MIXED FERTILIZER GRANULES

(71) Applicant: Tessenderlo Group NV, Brussels (BE)

(72) Inventors: Kristof GILS, Ham (BE); Peter LANDUYT, Ham (BE); Peter LUTS, Tessenderlo (BE); Nicolas WHITE, Maresches (FR)

(21) Appl. No.: 18/008,974

(22) PCT Filed: Jun. 10, 2021
(86) PCT No.: PCT/EP2021/065728

§ 371 Date: Dec. 8, 2022

(30) Foreign Application Priority Data
Jun. 10, 2020 (EP) 20179263.7

(51) Int. Cl. C05G 5/12; C05D 1/04

(52) U.S. Cl. CPC C05G 5/12; C05D 1/04

(57) ABSTRACT

The present invention relates to a fertilizer in granular form comprising within the same granule a mixture of: (A) From 15 to 85 wt % of a potassium sulfate; and (B) From 85 to 15 wt % of at least one salt that is different from (A) and that provides potassium and/or magnesium and/or calcium and/or sulfate; wherein the fertilizer in granular form has—a potassium level (expressed as K2O) of at least 18 wt %, preferably at least 20 wt %;—a chloride level of at most 10 wt %, preferably at most 5 wt %, more preferably at most 3 wt %;—a magnesium level (expressed as MgO) of at most 10 wt %, preferably at most 9.5 wt %. Materials of the invention are free flowing & combine a good nutrient balance with a good hardness and wear resistance.

### FIELD OF THE INVENTION

The present invention relates to the field of fertilizers, more in particular to the field of mixed fertilizers in granular form that are free flowing, have sufficient hardness and a good wear resistance.

### BACKGROUND OF THE INVENTION

Fertilizers are well known for agricultural and horticultural application. A number of nutrients are thereby supplied to the soil or growing medium of the plants. Nutrients such as nitrogen, phosphorous, potassium, calcium, magnesium and sulfur are supplied in relatively large amounts, while many other elements are supplied in lower amounts, as micronutrients.

Solid fertilizers exist in the form of granules, prills, powder and crystals. SOP (sulfate of potash) is primarily sold as granular fertilizer and is often combined (via bulk blending) with other fertilizers such as an N or P fertilizer.

Farmers want K fertilizers that are easy to spread on the field together with N or P fertilizers. The fertilizer industry wants products that are free flowing, that are easy to pack, store and transport and that present low segregation. When particles have a good hardness and wear resistance, then particles will break less easily and will be easier to coat.

The industry continuously looks for new forms of K fertilizers with a good nutrient balance, high enough K content and low enough chloride content.

It is not always simple to combine different fertilizers or nutritional elements within a same fertilizer granule, due to a difference in properties and behavior.

Lately, there has been interest in the use of evaporite minerals such as polyhalite, schoëenite, leonardite, langbeinite etc. Polyhalite is an evaporite mineral, a hydrated salt of potassium, magnesium and calcium with formula: K₂Ca₂Mg(SO₄)₄·2H₂O. Schöenite (or picromerite) is another saline evaporite, consisting of a mixed potassium and magnesium sulfate, of the chemical formula K₂Mg(SO₄)₂·6(H₂O). Leonardite and langbeinite are other examples of a mixed potassium & magnesium salt.

The problem with polyhalite is that it is difficult to granulate. It is a coarse material and under regular conditions the deformation of polyhalite particles is difficult. The same for schöenite and for other mixed or double sulfate salts. Another problem with polyhalite and the like is the low(er) K₂O level and a too low K₂O/MgO ratio.

WO2019/086062 describes fertilizer granules that consist essentially of potassium, magnesium, calcium and sulfate and that contain polyhalite, blended with potash (KCl). Granules described therein contain at most 13 wt % of potassium.

WO2018/146884 describes a polyhalite granulation process. Yet, granules obtained have a too low K₂O level for many applications and a too low hardness.

WO2018/229757 describes a compacted polyhalite and potash (KCl) mixture. Chloride levels, due to the high amount of KCl, in this case are too high for general use and especially for chloride sensitive crops. In this document, one mentions that unique compacting conditions are needed to granulate polyhalite.

### DESCRIPTION

The invention provides a fertilizer in granular form comprising within the same granule a mixture of: on the total of salts,
(A) from 15 to 85 wt % of potassium sulfate (K₂₅₀₄, also called Sulfate of Potash, or SOP); and
(B) from 85 to 15 wt % of at least one salt that is different from (A) and that provides potassium and/or magnesium and/or calcium and/or sulfate;
wherein the fertilizer in granular form has
   a potassium level, expressed as K₂O, of at least 18 wt %, preferably at least 20 wt %;
   a chloride level of at most 10 wt %, preferably at most 5 wt %, typically at most 3 wt %; and
   a magnesium level, expressed as MgO, of at most 10 wt %, preferably at most 9.5 wt %.

The skilled person will understand that, as used herein, the 85 to 15 wt. % of at least one salt that is different from A refers to the sum content of all said salts different from A.

Preferably, the magnesium level (expressed as MgO) in any of the above is at most 9.9, 9.8, 9.7, 9.6 wt %, more preferably at most 9.5, 9.4, 9.3, 9.2, 9.1 or 9 wt %. When present, then the magnesium level is at least 0.001 wt %, preferably at least 0.01 wt %, more preferably at least 0.1 wt %, at least 0.5 wt %. In a preferred embodiment of the invention, the magnesium levels is at most 8.5, 8.4, 8.3, 8.2; 8.1, preferably at most 8, 7.9, 7.8, 7.7, 7.6, 7.5, 7.4, 7.3, 7.2, 7.1, 7 wt %.

The calcium levels (expressed as CaO) in any of the above preferably is at most 10, 9.9, 9.8, 9.7, 9.6 wt %, more preferably at most 9.5, 9.4, 9.3, 9.2, 9.1 or 9 wt %. When present, then the calcium level is at least 0.001 wt %, preferably at least 0.01 wt %, more preferably at least 0.1 wt %, at least 0.5 wt %. In a particular embodiment, the calcium level is at least 1, 1.5, 2, 2.5 wt %. In the same or another embodiment, the calcium level is at most 5, 4.5, 4 wt %.

Preferably, the potassium level (expressed as K₂O) of the fertilizer in granular form is at least 18, 19, 20, 21, 22, 23, 24 wt %, more preferably at least 25, 26, 27, 28, 29 wt %, most preferably at least 30 wt %.

Preferably, the sulfate level (expressed as SO₃) of the fertilizer in granular form is from 40 to 55 wt %, preferably from 40 to 50 wt %.

Preferably, the K₂O/MgO ratio (expressed as wt % ratio) is at least 3, 3.1, 3.2, 3.3, 3.4, preferably at least 3.5, 3.6, 3.7, 3.8, 3.9, more preferably at least 4, 4.5, 5, 5.5 or even at least 6 and more.

The term ‘wt %’ herein stands for ‘weight percentage’ or ‘percentage by weight’. Below details on preferred compositions and preferred features of the granular fertilizers of the invention, any of the above.

Preferably, the potassium sulfate (A) is present in the fertilizer in granular form in an amount of at least 15, 16, 17, 18, or 19 wt %, preferably at least 20, 21, 22, 23, 24, or 25 wt %, on the total of salts. Preferably, the salt (B) is present in the fertilizer in granular form in an amount of at least 15, 16, 17, 18, or 19 wt %, preferably at least 20, 21, 22, 23, 24, or 25 wt %, on the total of salts.

Preferably, on the total of salts, you have from 20 to 80 wt % of salts (A) and from 80 to 20 wt % of salts (B). More preferably, you have from 30 to 70 wt % of salts (A) and from 70 to 30 wt % of salts (B). Most preferably, you have from 40 to 60 wt % of salts (A) and from 60 to 40 wt % of salts (B). In a preferred embodiment of the invention, the sum of A+B, on the total of salts, is at least 80, 85, 90, 95, 96, 97, 98, or 99 wt %. Obviously, a sum of more than 100 wt % is not possible.

Preferably, on the total weight of the granular fertilizer, the potassium sulfate (A) is present in an amount of at least 15, 16, 17, 18, or 19 wt %, preferably at least 20, 21, 22, 23, 24, or 25 wt %. Preferably, on the total weight of the fertilizer, the salt (B) is present in an amount of at least 15, 16, 17, 18, or 19 wt %, preferably at least 20, 21, 22, 23, 24, or 25 wt %.

The above amounts (expressed in weight percentages) include the typical impurities, side products, residual reactants or possibly crystalline water, which typically remain and are not removed.

Preferably, the potassium sulfate (A) and the at least one salt (B) as described herein are distributed more or less homogeneously over the fertilizer granule, possible coatings not included.

In some embodiments of the invention, it may be preferred to use a potassium sulfate (A) that is produced via a Mannheim process, in a muffle furnace.

Salts (B) are salts that provide additional potassium and/or magnesium and/or calcium and/or additional sulfate. Salts (B) preferably are sulfate salts, and more preferably they are double salts or mixed salts. By “mixed” salts is meant that at least two different cations are provided by the salts, like for instance (1) potassium and (2) magnesium. Typically, salts (B) have a K₂O level below 45, 44, 43, 42, 41, 40, 39, 38, 37, more typically below 36, 35, 34, 33, 32, 31, even more typically below 30.

Preferred in the context of the invention are potassium magnesium salts and/or potassium magnesium calcium salts. Highly suitable are polyhalite and/or langbeinite and/or leonardite and/or schöenite and/or kieserite. Preferred are polyhalite and/or langbeinite and/or leonardite and/or schöenite. Most preferred are polyhalite and/or schöenite. It is often preferred to use the above (or mixtures thereof) in their calcined form. For compositions, see Table I.

Preferably, salts (B) are chosen from one or more of: calcined polyhalite, calcined langbeinite, calcined leonardite, calcined schöenite, and mixtures thereof (of any of these). Particularly preferred are calcined polyhalite and/or calcined schöenite.

In a preferred embodiment of the invention salts (B) consist of polyhalite and/or schöenite, more in particular consists of calcined polyhalite and/or calcined schöenite. In one particular embodiment of the invention, the salt (B) is polyhalite, is a mixture of calcined and non-calcined polyhalite, preferably is calcined polyhalite. In another particular embodiment of the invention, the salt (B) is schöenite, is a mixture of calcined and non-calcined schöenite, preferably is calcined schöenite.

Apart from the salts (A) and (B) the granules of the invention may further contain a binder, like a grinding binder or a binder containing materials that improve cohesion and/or hardness. Such binder may be of organic and/or of inorganic nature. Such binder may contain one or more of the following ingredients: water, chalk, sodium silicate, potassium silicate, fly ash, geopolymers, starch, cellulose gums, sucrose, lignosulfates, molasses, magnesium oxides, calcium oxides, lime, hydrated lime [Ca(OH)₂], bitumen, Portland cement, alganite, clays like bentonite, acids (nitric, hydrochloric, phosphoric, sulfuric acid), oils, waxes and the like. In particular, the use of lime and/or of hydrated lime, all than not in combination with a hydroxide like chalk was found to improve particle hardness.

Apart from the salts (A) and (B) and optionally a binder, the granules of the invention may further comprise other additives and coatings.

Examples of additives that may be added include dyes, pH aids, (elemental) sulfur, extra macronutrients or micronutrients that contain boron, zinc, manganese, nickel, molybdenum, copper, iron, chloride, sodium or combinations thereof, etc. Preferred are those that contain boron, zinc, manganese, nickel, molybdenum, copper, iron, or combinations thereof (of any of these).

The granules of the invention can also contain one or more coatings. The coating can be an antidust-coating and/or an anti-caking coating and/or a slow or controlled release coating and/or a coating that contains additional nutrients. Also possible are biodegradable coatings and/or oily coatings or waxy coatings that reduce dustiness.

Preferably, the granules of the invention have been polished or post-treated, and are waxed, oiled, glazed or the like to increase hardness and/or to reduce dustiness. Any oil (e.g. mineral oil) or any wax (e.g. slack wax, paraffin wax) standard in the art may be used to improve rheology and/or to decrease dustiness.

Advantageously, granules of the invention (or the fertilizer in granular form of the invention) on average have a hardness of at least 2, 2.1, 2.2, 2.3, 2.4, 2.5, 2.6, 2.7 kg. Preferably, the hardness is at least 2.8, 2.9 or at least 3 kg. The granules of the invention (or the fertilizer in granular form of the invention) have on average a wear of at most 15, 14, 13, 12, 11, 10, 9, 8, 7 wt %, preferably at most 6.5, 6, 5.5, 5, 4.5, 4, 3.5 wt %. Most preferably, the wear is at most 3 wt %.

The granules of the invention (or the fertilizer in granular form of the invention) typically have a particle size of between 1 and 6 mm, more preferably between 2 and 4 mm. Typically from 40 to 70% of the granules obtained with a method of the invention (further described) are between 2 and 4 mm in size. In one embodiment of the invention, from 40 to 50% of the granules obtained are between 2 and 4 mm. In a preferred embodiment of the invention, from 50 to 95%, even more preferably from 60 to 95%, typically from 60 to 90% of the granules obtained are between 2 and 4 mm in size.

The methods of the invention (further described) allow the production of granules that are sufficiently round and free flowing.

The mixed fertilizer in granular form of the invention, can be made in various ways. Typically, the granules of the invention are produced either through compaction or through a granulation process based on size enlargement, such as a wet tumbling granulation.

Granulation is a size enlargement operation by which a fine powder or finer material is agglomerated into larger granules in order to produce a specific size and shape, to improve flowability and appearance and to reduce dustiness. Size enlargement herein is preferably via tumble growth. Both dry and wet granulation exist but in the present context, a wet granulation and more in particular a wet tumbling granulation is preferred.

Below some preferred ways of making granules of the invention are described:

In a first embodiment of the invention, the fertilizer in granular form according to the invention is produced by a compaction process (I) that comprises the steps of:
(i) Providing a mixture comprising (a) potassium sulfate (A) and (b) at least one salt (B) that is different from (A) and that provides potassium and/or magnesium and/or calcium and/or sulfate;
(ii) Optionally: adding a binder, preferably a binder that comprises water, and mixing, typically until a homogeneous mixture is obtained;
(iii) Compacting said mixture in a compactor and obtaining granules;
(iv) Sieving of the granules thus obtained to retain granules that have a particle size between 1 and 6 mm, preferably between 2 and 4 mm.

In a second embodiment of the invention, the fertilizer in granular form according to the invention is produced by a granulation process (II), more in particular a wet tumbling granulation process (II), said process comprising the steps of:
(i) Providing a mixture comprising (a) potassium sulfate (A) and (b) at least one salt (B) that is different from (A) and that provides potassium and/or magnesium and/or calcium and/or sulfate;
(ii) Adding (the needed amount of) water, and optionally, adding other binders;
(iii) Mixing, typically until a homogeneous mixture is obtained;
(iv) Forming granules of the desired particle size in a granulator, preferably a wet tumbling granulator;
(v) Drying of the granules;
(vi) Optionally: sieving of the granules thus obtained to retain granules that have a particle size between land 6 mm, preferably between 2 and 4 mm.

Examples of granulators that can be used in the process (II) include but are not limited to wet tumbling granulators like disc, drum, pan granulators, rotary drum granulators, gear and rotary drum granulators and the like. Another word for “granulator” is “pelletizer”. Though spray and melt granulation theoretically could be used too, it is less preferred in the context of the present invention. Best results we obtained with wet tumbling granulators including disc, drum and pan granulators.

Below, preferred ways of operation are provided. What is mentioned below in general applies to any process of the invention [any process (I) or any process (II) as described herein], unless indicated otherwise.

Information on typical amounts in the mixed fertilizer in granular form of salts (A), and of salts (B), this relative to the total of salts, has been given above. Salts (A) and (B) are typically used in such amounts that you have from 15 to 85 wt % of salts (A) and from 85 to 15 wt % of salts (B), from 20 to 80 wt % of salts (A) and from 80 to 20 wt % of salts (B), relative to the total of salts. More preferably, you have from 30 to 70 wt % of salts (A) and from 70 to 30 wt % of salts (B). Most preferably, you have from 40 to 60 wt % of salts (A) and from 60 to 40 wt % of salts (B). Obviously, the sum of A+B, on the total of salts, cannot be higher than 100 wt %. In a preferred embodiment of the invention, the sum of A+B, on the total of salts, is at least 80, 85, 90, 95, 96, 97, 98, or 99 wt %.

The potassium sulfate (A) can have the following origin. It can be:
Mined and processed to clean away unwanted salts, or
Produced from the reaction of potassium chloride with sulfuric acid in a potassium sulfate furnace, following e.g. a Mannheim process.

In some embodiments of the invention, it can be beneficial to use a potassium sulfate (A) that is produced in a potassium sulfate furnace, via the Mannheim process. Alternatively, a potassium sulfate (A) derived from an evaporite mineral can be used. For instance, a potassium chloride can be reacted with various sulfate salts to form a double salt that can then be decomposed to yield potassium sulfate (A). The sulfate salt reacted with the potassium chloride can be a sodium sulfate (in the form of mirabilite and/or sulfate brine) and/or a magnesium sulfate (in the form or kieserite and/or epsomite).

In a particular embodiment of the invention, the potassium sulfate (A) is at a temperature of between 100 and 400° C.; more particular at a temperature between 150 and 400° C., when it is mixed with salts (B). Particularly preferred is a potassium sulfate (A) that has just left the cooling drum after the muffle furnace, when it has a temperature of near 200° C. or near 300° C.

Preferred salts (B) have been listed above, and as indicated above, salts (B) preferably are used in their calcined form. When not purchased as such, then the process of the invention (any of the above) preferably comprises a calcination step (of salts (B)) prior to the mixing of salts (B) with salts (A). Eventually it is possible to use a mix of partly calcined and partly non-calcined salts (B).

Schöenite and Polyhalite are generally available as a coarse powder, and potassium sulfate is often in the form of granules or in the form of a powder. It is preferred, however, in the context of the invention to start from materials with a size no bigger than 1000, 900, 800, 700, 600 μm, preferably no bigger than 500, 400 μm, more preferably no bigger than 300 μm. This can be achieved by crushing and/or sieving of salts (A) and/or salts (B), where needed. In a preferred embodiment, at least 80, 85, 90, 91, 92, 93, 94, 95, 96, 97, 98, even 99 wt. % of the sum amount of salts (A) and (B) that are provided in step (i) have a particle size of no more than 500 μm, preferably no more than 300 μm.

Crushing machines that can be used include semi-wet material crushers, chain crushers, hammer mill crushers and the like. Sieving in general consists of passing the materials through subsequent sieves, starting for instance at 5 mm and ending with 300 μm.

In an embodiment of the invention, a step of crushing and/or sieving precedes step (i). Usually, a step of crushing and/or sieving follows step (i). Preferably, the step of crushing and/or sieving precedes the step of adding water, and optionally other binder materials. Examples of suitable and preferred binding materials can be found above.

Mixing of the salts (A) and (B) and possibly further ingredients like a binder (examples above) is straight forward. Any mixer can be used that leads to a more or less homogeneous mixture. The mixer used in a process of the invention (any of the above) can be a horizontal or vertical mixer, a paddle mixer or ploughshare mixer, a turbomixer, a pin mixer or the like. In the granulation method (II) the mixing can be in the granulator, like for instance a pan or a disc pelletizer. Preferred however is to have a (separate) mixing step before the pelletizer.

The amount of water that is added depends on the production process. The person skilled in the art knows the amount of water that is needed for a given production process. For instance, when compaction (I) is used then typically from 0.5 to 3 wt % of water is added. Most typically from 1 to 2 wt % of water is then used. In a wet granulation process (II); more in particular a wet tumbling granulation process, typically a higher amount of water is added, up to maximally 15 wt %, most often from 7 to 10 wt % of water is then added. Water preferably is added step-wise, and most preferably, water is added by spraying.

In a particular embodiment, the process of the invention (any of the above) comprises a step of adding elemental sulfur, more in particular molten elemental sulfur (e.g. at 140° C.).

In the same or another embodiment, the process of the invention (any of the above) comprises a step of adding micronutrients. Preferred micronutrients in the context of the invention are micronutrients that contain boron, zinc, manganese, nickel, molybdenum, copper, iron, chloride, sodium, iodine or combinations thereof, etc. Preferred are those that contain boron, zinc, manganese, nickel, molybdenum, copper, iron, iodine, or combinations thereof (of any of these).

Micronutrients can be added at various moments along the production process. They can be added to a hot potassium sulfate that just left the muffle furnace, e.g. just left the cooling drum after the muffle furnace, they can be added post production but prior to granulation, during granulation, or eventually they can be added to a coating.

The compaction step in a process (I) preferably is preceded by a step of pre-compaction as this increases hardness. The granulation step in a process (II), is preferably preceded by a step that enhances seed formation. Often the pre-treatment in a process (II) consist of 2 steps. A first step may consist of the crushing and/or sieving of the feed materials that were mixed to reduce particle size to at most 1000, 900, 800, 700, 600 μm, preferably at most 500, 400 μm, most preferably at most 300 μm (see above). Hereby a fine powder is typically formed. Devices that can be used for the crushing are e.g. a hammer mill, a pin mill and the like. The second step of this pre-treatment typically comprises a mixing step, useful in particular when multiple starting materials are used. For this purpose plough shear mixers, paddle mixers, screw mixers and the like can be used. This pre-treatment typically results in the formation of some pre-seeds. The mixture with pre-seeds is then transferred to a wet granulator, typically a wet tumbling granulator.

Suitable wet tumbling granulators for use in a process (II) include disc, drum, pan granulators and a range of similar equipment. In tumbling granulators, particles are set in motion by the tumbling action caused by the balance between gravity and centrifugal forces. Disc and pan pelletizers are generally preferred. Tilt angle)(°, speed (rpm) and depth (cm) of the pan or disc have an impact on the size, consistency and also the hardness of the granules obtained. A person skilled in the art will be able to set these parameters to achieve the desired end-product.

Various types of compactors can be used in a process (I) though preferred are the typical roller compactors. Then typically plaques of 10 to 15 mm thick are formed, that are then crushed with a hammer and/or a grid granulator to form granules. As mentioned above, it is preferred to use a step of pre-compaction in particular when a roller compactor is used.

After granulation the granules typically still need to be dried because their water content and strength cannot reach the standard.

The drying of the granules in step (iv) of process (II) typically is done with hot air and/or hot gas. The drying can be in a tumble dryer, drum dryer and/or in a fluidized bed dryer. Most typically, the drying step is done in a fluidized bed.

The dried granules are then usually sent to a cooler, most often by belt conveyor, to cool near room temperature (20-25° C.), so that the strength of the granules is improved and their water content is even further reduced. Sometimes transport by belt conveyor suffices in itself to cool down the dried granules. In other instances, cooling can be done in the same fluid bed dryer that was used for drying, in a second zone with cold air.

Optionally, the process of the invention (any of the above) can further provide a step of providing one or more coatings. Examples of coatings that can be provided are given above.

Optionally, the process of the invention (any of the above) further comprises a step of polishing and/or post-treatment comprising but not limited to glazing, further drying, oiling and/or waxing. These steps help to decrease e.g. dustiness and improves the hardness of the granules.

Possibly the process of the invention (any of the above) further contains a step of removing dust that is formed, for example with the aid of a fluidized-bed or a cascade system with wash decks combined with a cloth filter.

Optionally, the process of the invention (any of the above) can further comprise a step of rounding the granules obtained to increase the flowability.

Optionally the process of the invention (any of the above) comprises a further step of screening to remove any materials that are either undersized or oversized, prior to a possible finishing step, polishing step or post-treatment step.

Often, the screening step comprises one or more sieving steps to retain particles of the desired particle size. Screening or sieving, in the context of the invention, aims to retain particles that have a particle size between 1 and 6 mm, preferably between 2 and 4 mm. Preferably at least 90 wt. % of the particles have a particle size between 1 and 6 mm, preferably between 2 and 4 mm.

Undersized particles can be added again to the feed of salts (A) and/or (B). Oversized particles can be used again also, typically after a step of crushing and/or sieving so that the particle size does not exceed 1000, 900, 800, 700, 600 μm, preferably does not exceed 500, 400 μm, most preferably does not exceed 300 μm. Often materials pass multiple sieves of different size to obtain the smaller particle size.

The fertilizer in granular form that can be obtained with a process of the invention typically has a particle size between 1 and 6 mm, preferably between 2 and 4 mm. Preferably, more than 90% of the particles (by weight) have a size between about 1.5 and about 5 mm. More preferably, more than about 95% of the particles (by weight) have a size between about 1.5 and about 5 mm. A range with at least about 80, 85, 90% (by weight) between about 2 and about 4 mm is most preferred.

The hardness of the granules obtained preferably is about 2.0, 2.1, 2.2, 2.3 kg or higher, more preferably the hardness is 2.4, 2.5 kg or higher, more preferably about 3 kg or higher. The hardness of the granules most preferably is at least 3.5, 4, 4.5 or even 5 kg. The wear of the granules obtained typically is at most 15, at most 10 wt %, preferably at most 5 wt %. More typical values of hardness and wear can be found above.

Qualified products (or qualified granules of the invention) are then typically packed or stored. Storage on concrete floors is possible though storage in silos prior to transport including bulk transport, or prior to packaging, may be preferred.

Granules of the invention are highly suitable for the use together with another type of granular fertilizer, such as an N, S, P or K fertilizer (different from the one of the invention). Preferably, the granules of the invention have a SGN number (size guide number) that differs at most 15, preferably at most 10 with the granule of the N, S, P or K fertilizer.

Hence, another aspect of the invention relates to a (solid) fertilizer comprising the fertilizer in granular form of the invention and further at least one of ammonium nitrate, calcium ammonium nitrate, ammonium sulfate, monoammonium phosphate, diammonium diphosphate, ureum, phosphogypsum, single superphosphate, triple superphosphate, fertilizers that provide one or more micronutrients like zinc, iron, boron, manganese, molybdenum and/or copper, multinutrient fertilizers such as binary fertilizers (NP, NK, PK) and NPK fertilizers.

Fertilizers of the invention can be applied to a variety of food crops, including fruits and vegetables, rice, wheat and other grains, sugar, corn, soybeans, palm oil and cotton, all of which benefit from the supply of potassium. The fertilizers of the invention are further suited for use on crops that do not tolerate high chloride sensitive such as hop, tobacco, potato, many fruits and berries, early vegetables, all crops under glass, flowers, seedlings and transplants.

Measuring methods, as used throughout the invention, including the Examples section.
Color was measured via a Colorimeter (type Minolta CR 310).
K-content in examples was determined via the volumetric NaTPB-method (ISO 5310, AOAC 958.02) and recalculated as K2O.
S-content was determined via XRF (X-ray Fluorescence) and recalculated as SO3
Cl-content was determined via AgNO3-titration.
Mg- and Ca-content were determined via ICP-OES (Inductively Coupled Plasma—Optical Emission Spectrometry) and recalculated as respectively MgO and CaO.
Particle size analysis: the particles were screened over several sieves, and respective fractions were measured (on weight basis).
The Hardness (or crushing strength) of the granules is measured using standard testing methods for fertilizer granular hardness. Herein a commercial compression tester (Type Indelco 201-M) is used for measuring the hardness. A sample of the granular product is screened to obtain granules of about 3 mm in diameter. Individual granules are then placed on a flat surface and pressure is applied by a flat-end rod that is attached to the compression tester. The force (expressed in kg) needed to fracture the granule is measured. The reported value is the average of 20 individual granules.
The wear resistance of the granules is measured as follows: 100 g of the granules without particles less than 0.63 mm are put in a tube (length 40 cm and diameter 4 cm) and tumbled during 1 hour at 40 rpm. Finally, the granules are sieved and the fraction smaller than 0.63 mm is measured. The lower this fraction <0.63 mm, the higher the wear resistance of the granules (and vice versa).
The water content is determined gravimetrically by measuring the weight loss of the granules after heating to max. 105° C. until a constant weight, for instance by keeping the granules for 1 hour at 105° C. or overnight at 80° C., typically in a lab oven.

The invention is further described and detailed in the following Examples, which in no way are intended to be limiting.

### EXAMPLES

### Material Preparation

Polyhalite (salt B): was used in the following forms: (i) untreated, as coarse powder, (ii) crushed and sieved at 300 μm, (iii) crushed and calcinated.

Potassium sulfate (salt A): was used in the following forms: as a hot potassium sulfate (at 200° C.) in powder form just leaving the muffle furnace, (ii) as a potassium sulfate (at room temperature) with a size below 500 μm, or below 300 μm.

Calcination: of polyhalite was performed using a lab oven at 600° C.

Granulation: A series of tests were conducted with polyhalite and with polyhalite combined with potassium sulfate

Granulation was done in a disk pelletizer: Briefly, 1000 g of salts (A) and 1000 g salts (B) were mixed for a few minutes in a pin mixer for homogenization of the salts. Materials were then transferred to a rotating disc pelletizer with an angle set somewhere between 40° and 60°. About 10% water was used as binder & added step-wise in a semi-continuous way. Particles obtained were dried for 4 hours in an oven at 80° C. prior to analysis. To determine particle size distribution, particles were sieved (2-4 mm).

### Examples 1R-3R and 4-8

A series of tests were conducted with at one hand polyhalite alone and on the other hand polyhalite combined with SOP (salts B and A respectively) with the use of a disk pelletizer to achieve flowable particles. Hardness, wear, flowability and particle size distribution were compared (Table II). Granular SOP herein served as a reference.

Granulation of pure polyhalite (PH) without pretreatment resulted in poor hardness, most likely due to the coarse structure of the raw material. The combination of PH and SOP lead to a higher hardness overall compared to pure PH. Crushing, sieving and calcination improved hardness and/or wear resistance.

Where pure SOP particles are free flowing, this was not the case for pure PH particles. The addition of SOP improved flowability and leads to a fertilizer with a better balanced nutrient composition. Because of, amongst others, its free flowing property and low chloride content, the granular fertilizer of the invention is widely applicable. Furthermore, particle size distribution was more easy to control compared to polyhalite only. In addition, the granular fertilizer of the invention can be easily combined with other types of solid fertilizers standard in the art.

Comparable results can be obtained with schöenite and langbeinite.

TABLE I
Composition of salts B

| | K₂O | MgO | SO₃ | Cl⁻ |
|---|---|---|---|---|
| Mineral | (wt %) | (wt %) | (wt %) | (wt %) |
| Langbeinite | 22 | 18 | 55-56 | 1-3 |
| Polyhalite | 14 | 6 | 48 | <5 |
| Schöenite | 21-24 | 5-6 | 35-40 | 2-3 |

Fertilizers in granular form according to the invention were also produced via a compaction process (I). Particle hardness varied from 1 to 3 kg but in general particle hardness was >2 kg. Wear in this case was <3 wt %. K₂O levels were near 32-33% (Table II).

TABLE II
Materials tested and their characteristics

| | Composition | Pretreatment/ | K₂O | SO₃ | MgO | CaO | K₂O/MgO | Hardness | Wear |
|---|---|---|---|---|---|---|---|---|---|
| Test | (wt % on salts) | Particularity | (wt %) | (wt %) | (wt %) | (wt %) | (wt % ratio) | (kg) | (wt %) |
| 1R | PH, 100 | | 14 | 48 | 6 | 17 | <3 | <1 | 7 |
| 2R | PH, 100 | Sieved at 5 mm | 14 | 48 | 6 | 17 | <3 | <2 | 6 |
| 3R | PH, 100 | Crushed and calcinated | 14 | 48 | 6 | 17 | <3 | >2 | <1 |
| 4 | PH, 20, | Hot SOP at 200° C. | 21 | 47 | 5 | 14 | >4 | near 3 | near 10 |
| | SOP, 80 | | | | | | | | |
| 5 | PH, 50 | Hot SOP at 200° C. | 32 | 47 | 3 | 9 | >10 | near 4 | 3 |
| | SOP, 50 | Crushed | | | | | | | |
| 6 | PH, 20 | | 21 | 47 | 5 | 14 | >4 | >2 | 4 |
| | SOP, 80 | | | | | | | | |
| 7 | PH, 80 | | 43 | 46 | 1 | 3 | >>30 | >2 | 2 |
| | SOP, 20 | | | | | | | | |
| 8 | PH, 50 | Crushed and calcinated | 32 | 47 | 3 | 9 | >10 | >5 | <5 |
| | SOP, 50 | | | | | | | | |

PH = polyhalite, SOP = potassium sulfate, Hot SOP at 200° C.: SOP that just left the muffle furnace

1. A fertilizer in granular form comprising within the same granule a mixture of:
on the total of salts,
(A) from 15 to 85 wt % of potassium sulfate; and
(B) from 85 to 15 wt % of at least one salt that is different from (A) and that provides potassium and/or magnesium and/or calcium and/or sulfate;
wherein the fertilizer in granular form has
a potassium level, expressed as K₂O, of at least 18 wt %, preferably at least 20 wt %;
a chloride level of at most 10 wt %, preferably at most 5 wt %, typically at most 3 wt %; and
a magnesium level, expressed as MgO, of at most 10 wt %, preferably at most 9.5 wt %.

2. The fertilizer of the preceding claim, with a magnesium level, expressed as MgO, of at most 9 wt %.

3. The fertilizer of any of the preceding claims with a K₂O/MgO ratio of at least 3, preferably at least 3.2.

4. The fertilizer of any of the preceding claims with a potassium content, expressed as K₂O, of at least 25 wt %, preferably at least 30 wt %.

5. The fertilizer of any of the preceding claims, comprising on the total of salts, at least 20 wt %, of salts (A).

6. The fertilizer of any of the preceding claims comprising, on the total of salts, from 20 to 80 wt % of salts (A) and from 80 to 20 wt % of salts (B).

7. The fertilizer of any of the preceding claims wherein the salt (B) is selected from at least one of: polyhalite and/or langbeinite and/or leonardite and/or schöenite.

8. The fertilizer of any of the preceding claims having an average hardness of at least 2 kg, preferably at least 2.5 kg and an average wear resistance of at most 5 wt %.

9. The fertilizer of any of the preceding claims further comprising at least one macronutrient or micronutrient that contains boron, zinc, manganese, nickel, molybdenum, copper, iron, or combinations thereof and/or further comprising elemental sulfur and/or further comprising one or more dyes.

10. The fertilizer of any of the preceding claims provided with one or more coatings.

11. The fertilizer of any of the preceding claims, wherein at least 90 wt. % of the particles has a particle size between 1 and 6 mm, preferably between 2 and 4 mm.

12. A compaction process (I) for the making of a fertilizer in granular form of any of claims 1 to 11, said process comprising the steps of
(i) Providing a mixture comprising, on the total of the salts, (a) from 15 to 85 wt % of potassium sulfate (A) and (b) from 85 to 15 wt % of at least one salt (B) that is different from (A) and that provides potassium and/or magnesium and/or calcium and/or sulfate;
(ii) Optionally, adding a binder, preferably a binder that comprises water; and mixing typically until again a homogeneous mixture is obtained;
(iii) Compacting said mixture in a compactor and obtaining granules;
(iv) Sieving of the granules thus obtained to retain granules that have a particle size between 1 and 6 mm, preferably between 2 and 4 mm.

13. A granulation process (II) for the making of a fertilizer in granular form of any of claims 1 to 11, said process comprising the steps of:
(i) Providing a mixture comprising, on the total of salts, (a) from 15 to 85 wt % of potassium sulfate (A) and (b) from 85 to 15 wt % of at least one salt (B) that is different from (A) and that provides potassium and/or magnesium and/or calcium and/or sulfate;
(ii) Adding water, and optionally, adding other binders;
(iii) Mixing, typically until again a homogeneous mixture is obtained;
(iv) Forming granules of the desired particle size in a granulator, preferably a wet tumbling granulator;
(v) Drying of the granules;
(vi) Optionally, sieving of the granules thus obtained to retain granules that have a particle size between 1 and 6 mm, preferably between 2 and 4 mm.

14. The process of any of any of claims 12 to 13, wherein at least 90 wt. % of the sum amount of salts (A) and (B) that are provided in step (i) have a particle size of no more than 500 μm, preferably no more than 300 μm.

15. The process of any of any of claims 12 to 14, further comprising at least one of the following steps:
Adding micronutrients and/or elemental sulfur;
Providing one or more coatings;
Rounding the granules;
Glazing and/or oiling and/or waxing the granules;

16. A solid fertilizer comprising the fertilizer in granular form of any of claims 1 to 11, and further at least one further solid fertilizer that is different therefrom, such as ammonium nitrate, ammonium sulfate, ammonium phosphate, ammonium diphosphate and/or ureum.
